(19) United States
(12) Patent Application Publication
(10) Pub. No.: US 2025/0321608 A1
(43) Pub. Date: Oct. 16, 2025

(54) LOCAL CLOCK DRIVEN DETUNE ON A CONTINUOUS CLOCK GRID

(71) Applicant: International Business Machines Corporation, Armonk, NY (US)

(72) Inventors: Douglas J. MALONE, Pleansant Valley, NY (US); Lily Jielu ZHANG, Wappingers Falls, NY (US); Andreas H. A. ARP, Nufringen (DE); Daniel KISS, Stuttgart (DE); Ching Lung TONG, Highland Mills, NY (US); Jan Philipp KRESS, Boeblingen (DE); David Wen-Hao SHAN, Austin, TX (US)

(21) Appl. No.: 18/631,284

(22) Filed: Apr. 10, 2024

(51) Int. Cl. G06F 1/08; G06F 1/10

(52) U.S. Cl. CPC G06F 1/08; G06F 1/10

(57) ABSTRACT

Embodiments herein describe changing the strength of clock buffers used to drive different portions of a clock mesh. In one embodiment, the clock mesh may provide a clock signal to multiple different circuit elements in an integrated circuit. If one circuit element is not being used (e.g., a CPU does not need to use one of its cores), the clock buffer (or buffers) for the portion of the clock mesh that provides a clock signal to the circuit element can have its strength reduced, thereby saving power.

### BACKGROUND

Clock meshes are homogeneous shorted grids of metal that are driven by many clock buffers (also referred to as clock drivers). A clock mesh reduces skew by shorting the outputs of the clock buffers. Global clock meshes are large meshes that extend through an integrated circuit (IC), such as a processor with multiples cores, application specific integrated circuits (ASIC), systems on a chip (SoC), graphics processing units (GPUs), field programmable gate arrays, and the like.

During operation, certain portions (e.g., certain circuitry) in the IC may be unused. For example, a processor may not be currently using each of its cores. As such, driving a clock signal to the unused circuitry wastes power. However, with a clock mesh, it is often the case the portion of the mesh providing a signal to the unused circuitry cannot be turned off because this affects the timing of the clock signal in other circuitry that is currently being used. Thus, previous techniques such as performing clock gating where the clock is completely stopped in certain regions of the IC do not work with large clock meshes.

### SUMMARY

According to one embodiment of the present invention, a method includes identifying circuitry in an integrated circuit (IC) that is unused where a clock mesh in the IC provides a clock signal to the circuitry, and reducing a strength of a clock buffer that drives a portion of the clock mesh that provides the clock signal to the circuitry where the clock buffer continues to provide the clock signal to the circuitry but with a reduced strength relative to other clock buffers in the clock mesh that provide the clock signal to other circuitry in the IC.

According to one embodiment of the present invention, an IC includes a first circuit that is configured to be selectively used and unused to process data, a second circuit that is configured to remain active when the first circuit is unused, and a clock mesh that provides a clock signal to the first and second circuits where the clock mesh includes a first clock buffer configured to provide the clock signal to the first circuit and a second clock buffer configured to provide the clock signal to the second circuit. Moreover, the IC is configured to reduce the strength of the first clock buffer when the first circuit is unused, wherein the first clock buffer continues to provide the clock signal to the first circuit but with a reduced strength relative to the second clock buffer.

According to one embodiment of the present invention, a computer program product includes a computer-readable storage medium having computer-readable program code embodied therewith, the computer-readable program code executable by one or more computer processors to perform an operation. The operation includes identifying circuitry in an integrated circuit (IC) that is unused where a clock mesh in the IC provides a clock signal to the circuitry, and reducing a strength of a clock buffer that drives a portion of the clock mesh that provides the clock signal to the circuitry where the clock buffer continues to provide the clock signal to the circuitry but with a reduced strength relative to other clock buffers in the clock mesh that provide the clock signal to other circuitry in the IC.

### BRIEF DESCRIPTION OF THE DRAWINGS

FIG. 1 is a block diagram of an example computer environment for use in conjunction with one or more disclosed embodiments.

FIG. 2 illustrates an IC with controllable clock buffers, according to one embodiment.

FIG. 3 is a flowchart for changing the strength of at least one clock buffer corresponding to unused circuitry, according to one embodiment.

FIG. 4 is a flowchart for changing the strength of inner and outer sectors corresponding to unused circuitry, according to one embodiment.

FIG. 5 illustrates an IC where the inner and outer sectors corresponding to unused circuitry have been detuned, according to one embodiment.

### DETAILED DESCRIPTION

Embodiments herein describe changing the strength of clock buffers used to drive different portions of a clock mesh (e.g., a global clock mesh). In one embodiment, the clock mesh provides a clock signal to multiple different circuit elements in an integrated circuit (e.g., different types of circuitry or different instances of the same circuit element, such as multiple processor cores). If one circuit element is not being used (e.g., a CPU does not need to use one of its cores), the clock buffer (or buffers) for the portion of the clock mesh that provides a clock signal to the circuit element can have its strength reduced, thereby saving power. Unlike clock gating where a clock signal is blocked, here, the clock buffer can continue to drive a clock signal to the circuit element, albeit at reduced power. Turning off portions of a clock mesh can cause large skews which can make the clock signal no longer synchronous and can break timing for logic. Thus, “detuning” the clock buffers by changing their strength as proposed here can save power while reducing a negative impact on skew and maintaining the clock signal in a synchronous state.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as clock controller 182 which can change the strength of clock buffers in order to reduce or increase their strength. In addition to the controller 182, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and clock controller 182, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

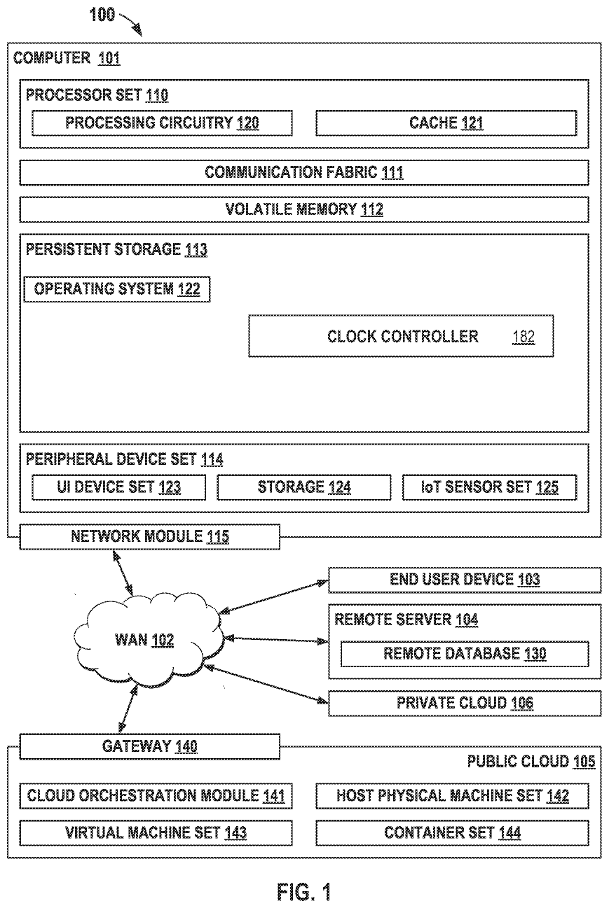

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in clock controller 182 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

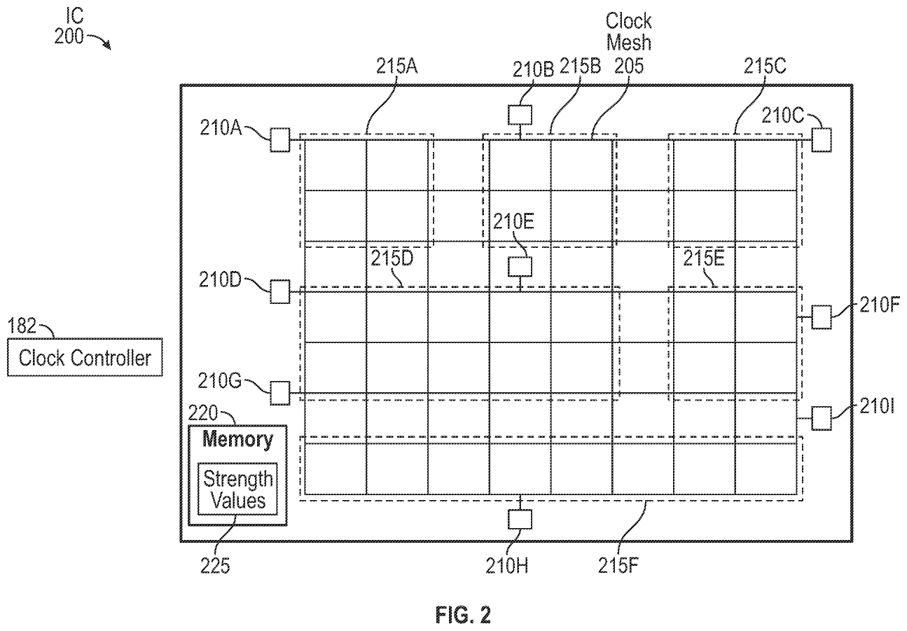

FIG. 2 illustrates an IC 200 with controllable clock buffers 210, according to one embodiment. As shown, the IC 200 includes a clock mesh 205. This clock mesh 205 can be a global clock mesh that provides a common clock signal to most, if not all, of the circuitry in the IC 200. For example, the clock mesh 205 may provide a clock signal to all the circuitry in the IC 200 except from input/output (IO) circuitry in the IC 200 which may use a different clock signal. However, the embodiments herein at not limited to using a global clock mesh but can apply to any clocking network that supplies a clock signal to multiple circuit elements using multiple clock buffers 210.

The dotted lines illustrate different circuit elements 215A-F in the IC 200. The circuit elements 215 can be different types of circuitry (e.g., processor cores, memory, controllers, logic gates, etc.) and can include different instances of the same circuitry (e.g., multiple cores of a processor).

The clock buffers 210A-I are distributed throughout the IC at different portions of the clock mesh 205. The clock buffers 210 can be synchronized to drive the same clock signal so the clock edges arrive at each of the circuit elements 215 at approximately the same time.

The IC 200 includes memory 220 (e.g., registers) that store strength values 225 for the clock buffers 210. For example, each clock buffer 210 may have a different register that stores its corresponding strength value 225. Put differently, each clock buffer 210 may be separately controllable using one of the strength values 225 in order to change (increase or decrease) its strength relative to the other clock buffers 210. In other another embodiment, groups of clock buffers 210 may be controlled with the same strength value. For example, the clock buffers 210A-E may be controlled by one strength value 225 while the clock buffers 210F-I are controlled by a second strength value 225. Changing one of these strength values 225 changes the strength of each clock buffer 210 in the corresponding group. The strength values 225 can be changed dynamically during operation of the IC 200.

The clock controller 182 can be software (as is the case in FIG. 1), firmware, or hardware (e.g., hardware disposed on the IC 200). The clock controller 182 can set the strength values 225 in order to control the strength of the clock buffers 210. For example, the clock controller 182 may determine (or be told by some other software application or hardware in the IC 200) that a particular circuit element 215 is not being used, and reduce the strength of the clock buffer 210 that drives a portion of the clock mesh 205 at or near the unused circuit element 215. For example, the circuit element 215 may be a core in a processor that is not currently being used. The clock controller 182 can change the strength value 225 for the clock buffer 210A which drives the portion of the mesh 205 at the circuit element 215A. For example, the strength values 225 can determine the number of field-effect transistors (FETs) that are connected and used in the clock buffers 210. By reducing the connected FETs, the strength of the clock buffer 210A is reduced which saves power. Moreover, the power reduction may be controlled so as not to negatively impact the neighboring portions of the clock mesh 205 that service circuit elements 215 that are still active (e.g., circuit elements 215B and 215D). For example, reducing the strength of the clock buffer 210A by, e.g., 25% may save power while not having a substantial impact of the neighboring circuits (e.g., skew remains within an acceptable tolerance and logic timing is maintained).

In another embodiment, the clock controller 182 can increase the strength of one or more of the clock buffers 210, relative to the strength of the other clock buffers. This may be useful to perform diagnostics on a particular circuit element 215. That is, the clock controller 182 could temporarily adjust the strength value 225 for the clock buffer 210A to perform a test on the circuit element 215A, while the strength of the other clock buffers 210B-I remains the same.

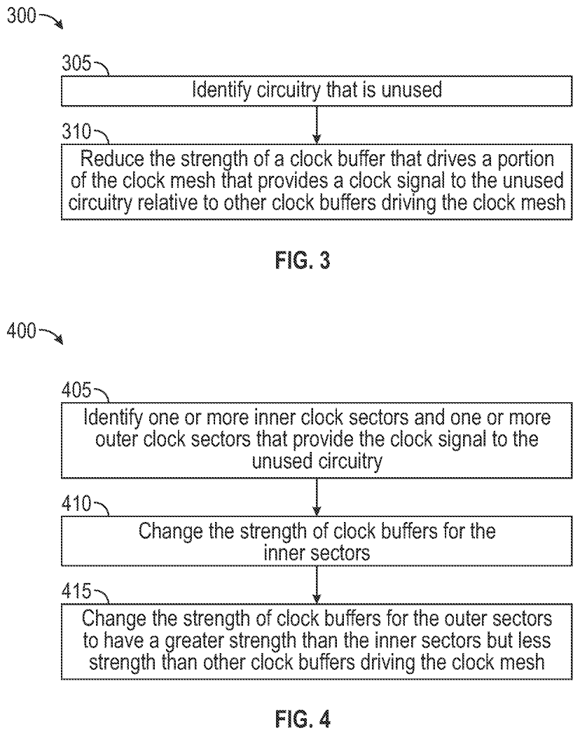

FIG. 3 is a flowchart of a method 300 for changing the strength of at least one clock buffer corresponding to unused circuitry, according to one embodiment. At block 305, the clock controller (e.g., the clock controller 182 in FIG. 1 or 2) identifies circuitry in an IC that is unused. This can include one or more unused cores in a processor (e.g., a CPU or GPU), unused interface circuitry, unused memory controller, and the like.

At block 310, the clock controller changes the strength of one or more clock buffers that drive a portion of the clock mesh that provides a clock signal to the unused circuitry, relative to other clock buffers driving the clock mesh. That is, the clock controller selectively reduces the strength of the clock buffers that drive the clock mesh, while the other clock buffers may remain unchanged. For example, changing the strength value stored in the register can change the number of FETs used to drive the clock buffer, thereby changing its strength.

The amount the strength is reduced can vary depending on the situation, such as proximity of the clock buffer to other, active circuitry, the clock speed, the size/area of the unused circuitry, and the like. In general, it may be advantageous to reduce the strength of the clock buffer as much as possible without producing a substantial negative impact on active circuitry (e.g., too much skew or causes timing to break).

While the method 300 described reducing (or detuning) the strength of the clock buffer, in other embodiments, the clock controller can identify active circuitry where the strength of a clock buffer should be increased, e.g., to perform a diagnostic test.

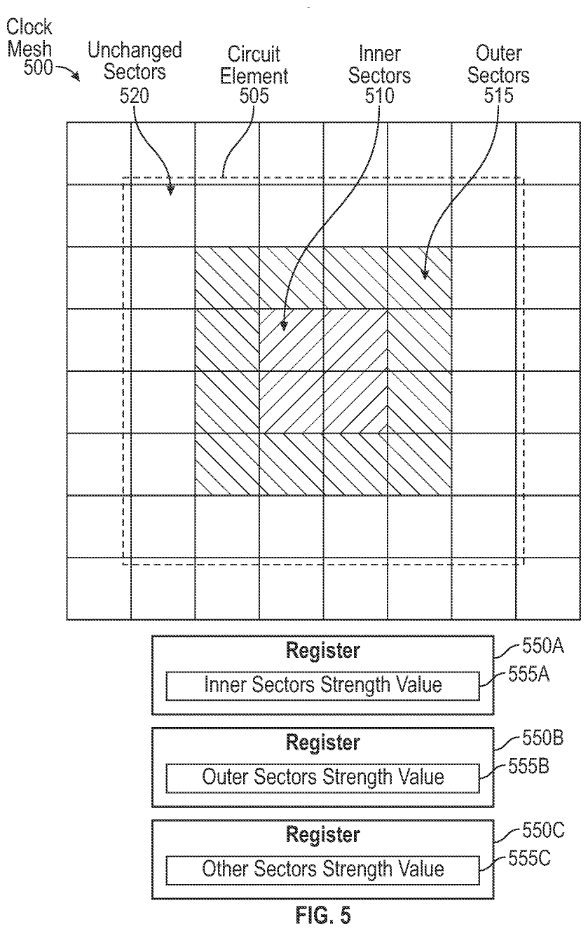

FIG. 4 is a flowchart of a method 400 for changing the strength of inner and outer sectors corresponding to unused circuitry, according to one embodiment. The method 400 can be one example of block 310 of FIG. 3 where the strength of the clock buffer is changed. For clarity, the method 400 is described in tandem with FIG. 5 which illustrates an IC where the inner and outer sectors corresponding to unused circuitry have been detuned.

At block 405, the clock controller identifies one or more inner clock sectors and one or more outer clock sectors that provide the clock signal to the unused circuitry. Referring to FIG. 5, it illustrates a clock mesh 500 divided up into a grid of clock sectors. Each sector may be driven by one or more clock buffers (not shown). FIG. 5 also illustrates an unused circuit element 505 using a dotted line. As shown, multiple clock sectors provide the clock signal to the circuit element 505. The inner sectors 510 include 4 clock sectors at the center of the circuit element 505 while the outer sectors 515 includes 12 clock sectors that surround the inner sectors 510.

At block 410, the clock controller changes the strength of the clock buffers for the inner sectors. This can include reducing the strength of the clock buffers that drive the inner sectors.

At block 415, the clock controller changes the strength of the clock buffers for the outer sectors. In one embodiment, these clock buffers have a greater strength than the clock buffers for the inner sectors. For example, the clock buffers for the outer sectors may have their strength reduced by 15% while the clock buffers for the inner sectors have their strength reduced by 25%. Moreover, the clock buffers for the other sectors of the clock mesh may be unchanged.

Returning again to FIG. 5, this example illustrates that some clock sectors that service the unused circuit element 505 may not have the clock buffers' strength changed. In this example, the unchanged sectors 520 are disposed around a periphery of the circuit element 505 (and surround the outer sectors 515). The clock buffers for the unchanged sectors may not be adjusted when the circuit element 505 is unused. Doing so may mitigate the negative impact that reducing the strength of the clock buffers for the inner sectors 510 and the outer sectors 515. That is, the unchanged clock sectors 520 can provide a buffer zone between the clock sectors where their clock buffer strengths are changed and clock sectors that service neighboring circuitry that is active. Thus, FIG. 5 illustrates that the clock sectors for unused circuitry elements can include sectors where the strength of the clock buffers is not changed (i.e., the unchanged sectors 520), sectors where the strength of the clock buffers is changed some (i.e., the outer sectors 515), and sectors where the strength of the clock buffers is changed more (i.e., the inner sectors 510). For example, the strength of the clock buffers can be reduced when moving to clock sectors at the center of the unused circuit element 505. However, this is just one example. In other scenarios it may save more power to reduce each clock sector at the circuit element 505 by the same amount.

FIG. 5 also illustrates registers 550A-C that store different strength values. That is, the register 550A stores a strength value 555A for the inner sectors 510, the register 550B stores a strength value 555B for the outer sectors 515, and the register 550C stores a strength value 555C for the unchanged sectors 520. That is, instead of having a register to store a strength value for every sector (or every clock buffer) in the clock mesh 500, one register can store a strength value for multiple sectors (or multiple clock buffers). Thus, the strength of the clock buffers in the multiple sectors can be adjusted in parallel by changing the same strength value. This can save memory space in the IC relative to an embodiment where each sector or clock buffer has a separate strength value. However, on the other hand, this means that the inner sectors 510 are controlled by the same strength value 555A, and thus, cannot be separately controllable. However, this may be acceptable since they provide a clock signal to the same circuit element 505, which may either be turned on or off as a whole. In this manner, a chip designer can identify clock sectors that will be controlled in the same manner, and use one register and strength value to control the clock buffers for those sectors, thereby saving memory in the IC. For instance, there may be clock sectors that correspond to circuit elements in the IC that will always be used. These clock sectors can be controlled by the same strength value, which may not change.

While the foregoing is directed to embodiments of the present invention, other and further embodiments of the invention may be devised without departing from the basic scope thereof, and the scope thereof is determined by the claims that follow.

What is claimed is:

1. A method comprising:
identifying circuitry in an integrated circuit (IC) that is unused, wherein a clock mesh in the IC provides a clock signal to the circuitry; and
reducing a strength of a clock buffer that drives a portion of the clock mesh that provides the clock signal to the circuitry, wherein the clock buffer continues to provide the clock signal to the circuitry but with a reduced strength relative to other clock buffers in the clock mesh that provide the clock signal to other circuitry in the IC.

2. The method of claim 1, wherein outputs of the clock buffer and the other clock buffers are shorted together in the clock mesh.

3. The method of claim 1, wherein the other clock buffers provide the clock signal to other circuitry in the IC that neighbors the circuitry, wherein the other circuitry remains active when the circuitry is unused.

4. The method of claim 1, further comprising:
identifying at least one inner clock sector and an outer clock sector of the clock mesh that provide the clock signal to the circuitry; and
reducing a strength of a clock buffer in the inner clock sector and a strength of a clock buffer in the outer clock sector, wherein the strength of the clock buffer in the inner clock sector is reduced more than the strength of the clock buffer in the outer clock sector.

5. The method of claim 4, wherein the inner clock sector is located in a center of the circuitry, and wherein the outer clock sector is disposed between the inner clock sector and a periphery of the circuitry.

6. The method of claim 5, wherein the outer clock sector is part of a plurality of outer clock sectors that provide the clock signal to the circuitry and that surround the inner clock sector, wherein strengths of clock buffers in the plurality of outer clock sectors are reduced less than the strength of the clock buffer in the inner clock sector.

7. The method of claim 1, further comprising:
identifying at least one inner clock sector disposed at a center of the circuitry and an unchanged clock sector disposed at a periphery of the circuitry, wherein both the inner clock sector and the unchanged clock sector provide the clock signal to the circuitry; and
reducing a strength of a clock buffer in the inner clock sector but not reducing the strength of a clock buffer in the unchanged clock sector, wherein the unchanged clock sector neighbors another clock sector that provides the clock signal to other circuitry in the IC that is active while the circuitry is unused.

8. The method of claim 1, further comprising:
reducing a strength of a plurality of clock buffers that drives the portion of the clock mesh that provides the clock signal to the circuitry using a same strength value stored in a register in the IC.

9. An IC, comprising:
a first circuit that is configured to be selectively used and unused to process data;
a second circuit that is configured to remain active when the first circuit is unused; and
a clock mesh that provides a clock signal to the first and second circuits, the clock mesh comprises a first clock buffer configured to provide the clock signal to the first circuit and a second clock buffer configured to provide the clock signal to the second circuit,
wherein the IC is configured to reduce the strength of the first clock buffer when the first circuit is unused, wherein the first clock buffer continues to provide the clock signal to the first circuit but with a reduced strength relative to the second clock buffer.

10. The IC of claim 9, wherein outputs of the first and second clock buffers are shorted together in the clock mesh.

11. The IC of claim 9, wherein the IC is configured to:
identify at least one inner clock sector and an outer clock sector of the clock mesh that provide the clock signal to the first circuit; and
reduce a strength of the first clock buffer in the inner clock sector and a strength of a third clock buffer in the outer clock sector, wherein the strength of the first clock buffer in the inner clock sector is reduced more than the strength of the third clock buffer in the outer clock sector.

12. The IC of claim 11, wherein the inner clock sector is located in a center of the first circuit, and wherein the outer clock sector is disposed between the inner clock sector and a periphery of the first circuit.

13. The IC of claim 12, wherein the outer clock sector is part of a plurality of outer clock sectors that provide the clock signal to the first circuit and that surround the inner clock sector, wherein strengths of clock buffers in the plurality of outer clock sectors are reduced less than the strength of the first clock buffer in the inner clock sector.

14. The IC of claim 9, wherein the IC is configured to:
identify at least one inner clock sector disposed at a center of the first circuit and an unchanged clock sector disposed at a periphery of the first circuit, wherein both the inner clock sector and the unchanged clock sector provide the clock signal to the first circuit; and
reduce a strength of the first clock buffer in the inner clock sector but not reducing the strength of a third clock buffer in the unchanged clock sector, wherein the unchanged clock sector neighbors another clock sector that provides the clock signal to the second circuit in the IC that is active while the first circuit is unused.

15. The IC of claim 9, further comprises:
a register configured to store a strength value that controls a strength of a plurality of clock buffers in the clock mesh that provides the clock signal to the first circuit, wherein the IC is configured to reduce the strength of the plurality of clock buffers in parallel by adjusting the strength value.

16. A computer program product, comprising:
a computer-readable storage medium having computer-readable program code embodied therewith, the computer-readable program code executable by one or more computer processors to perform an operation, the operation comprising:
identifying circuitry in an integrated circuit (IC) that is unused, wherein a clock mesh in the IC provides a clock signal to the circuitry; and
reducing a strength of a clock buffer that drives a portion of the clock mesh that provides the clock signal to the circuitry, wherein the clock buffer continues to provide the clock signal to the circuitry but with a reduced strength relative to other clock buffers in the clock mesh that provide the clock signal to other circuitry in the IC.

17. The computer program product of claim 16, wherein outputs of the clock buffer and the other clock buffers are shorted together in the clock mesh.

18. The computer program product of claim 16, wherein the operation further comprises:
identifying at least one inner clock sector and an outer clock sector of the clock mesh that provide the clock signal to the circuitry; and
reducing a strength of a clock buffer in the inner clock sector and a strength of a clock buffer in the outer clock sector, wherein the strength of the clock buffer in the inner clock sector is reduced more than the strength of the clock buffer in the outer clock sector.

19. The computer program product of claim 18, wherein the inner clock sector is located in a center of the circuitry, and wherein the outer clock sector is disposed between the inner clock sector and a periphery of the circuitry,
wherein the outer clock sector is part of a plurality of outer clock sectors that provide the clock signal to the circuitry and that surround the inner clock sector, wherein strengths of clock buffers in the plurality of outer clock sectors are reduced less than the strength of the clock buffer in the inner clock sector.

20. The computer program product of claim 16, wherein the operation further comprises:
identifying at least one inner clock sector disposed at a center of the circuitry and an unchanged clock sector disposed at a periphery of the circuitry, wherein both the inner clock sector and the unchanged clock sector provide the clock signal to the circuitry; and
reducing a strength of a clock buffer in the inner clock sector but not reducing the strength of a clock buffer in the unchanged clock sector, wherein the unchanged clock sector neighbors another clock sector that provides the clock signal to other circuitry in the IC that is active while the circuitry is unused.
